(19) United States
(12) Patent Application Publication
(10) Pub. No.: US 2009/0206700 A1
(43) Pub. Date: Aug. 20, 2009

(54) Piezo actuator with a plug connection

(76) Inventors: Rudolf Heinz, Renningen (DE); Dieter Kienzler, Leonberg (DE); Udo Schaich, Stuttgart (DE)

Correspondence Address: KENYON & KENYON LLP, ONE BROADWAY, NEW YORK, NY, 10004, US

(21) Appl. No.: 11/990,820

(22) PCT Filed: Jul. 19, 2006
(86) PCT No.: PCT/EP2006/064390

§ 371 Date: Apr. 22, 2009

(30) Foreign Application Priority Data
Aug. 22, 2005 (DE) 10 2005 039 548.1

(51) Int. Cl. H02N 2/04; H01R 33/06

(52) U.S. Cl. 310/328; 439/577

(57) ABSTRACT

A piezo actuator in the form of a piezo injector, includes a holding body having an inner space, and having a piezo element disposed in an inner space and encompassing multiple piezoelectric plies disposed to form a stack, which element is electrically contactable through the holding body. The holding body has one or more connectors for electrical contacting of the piezo element, as well as one or more connectors and flow conduits for delivering into the inner space a fluid that can be metered by way of an adjusting member encompassing the piezo element, such that in the piezo actuator, the flow conduit connecting the inner space and the connector for the fluid is offset radially outward with respect to the electrical conductors leading through the holding body and substantially constituting the electrical contact system, and is disposed to extend substantially parallel to said conductors; and a plug connection connecting the piezo element to the electrical conductors is disposed between the holding body and piezo element.

### FIELD OF THE INVENTION

The present invention relates to a piezo actuator, in particular constituting a piezo injector, having optimized installation space for an electrical plug connection disposed between a piezo element and a holding body, for example for actuation of a mechanical component such as a valve, a nozzle needle, or the like.

### BACKGROUND INFORMATION

It is believed to be understood that in order to construct a piezo actuator or piezo injector, a piezo element may be used in such a way that, exploiting the so-called piezo effect, control can be exerted on a needle stroke of a valve or the like. The piezo element is constructed from a material having a suitable crystal structure, in such a way that upon application of an external electrical voltage, a mechanical reaction of the piezo element occurs, representing a pressure or tension in a definable direction depending on the crystal structure and the regions in which the electrical voltage is applied. Piezo actuators of this kind are suitable in particular for applications in which linear stroke motions occur with large actuation forces and at high cycle frequencies.

For example, a piezo injector of this kind, which can be used to apply control to the injection needles in injectors for injecting fuel into the combustion chamber of an internal combustion engine, is discussed in DE 100 26 005 A1. In this piezo actuator a piezo element is constructed, as mentioned, as a stack of multiple piezoceramic layers electrically coupled to one another, which is held under a preload between two stops. Each piezoceramic layer is gripped, as a piezoelectric ply, between two internal electrodes through which an electrical voltage can be applied from outside. As a result of this electrical voltage, the piezoceramic layers then each perform small linear stroke motions in the direction of the potential gradient which then add up to the total stroke of the piezo actuator. This total stroke is modifiable by way of the magnitude of the applied voltage, and can be transferred to a mechanical adjusting member.

In addition, EP 1 174 615 A3 discusses a piezo actuator in which a piezo element is present as an actuator for direct needle stroke control of a fuel injector for an internal combustion engine. Sitting between the piezo element, constituting an actuator, and the needle is only a coupler having a hydraulic conversion ratio for expansion compensation. Upon an activation of the piezo element in this context, the needle—held under a preload in order to seal the injection nozzle—is moved away from the nozzle opening, since the needle follows the motion of the actuator by direct transmission. The piezo element, coupler, and needle constitute parts of an adjusting member with which, e.g. in an injector, fuel or another fluid, for example, can be injected in metered fashion, for example, into the combustion chamber of an internal combustion engine.

FIG. 2 schematically shows the construction of a single-stage piezo actuator 1 according to the existing art that can be used, for example, to control the needle stroke in the fuel injection system of an internal combustion engine. Present in the upper part is a holding body 2 that can be adapted in terms of its geometric dimensions substantially to the particular intended application and to the specific location of use. Present on holding body 2 is a plug part (not depicted here) with which, in the context of a plug embodiment likewise specifically adapted to the particular application, electrical voltage can be connected in order to apply control to a piezo element 3 disposed in an inner space 4 of holding body 2.

Wires (not depicted here) constituting electrical conductors are guided from the plug part to external electrodes (likewise not depicted) on piezo element 3 for electrical contacting of piezo element 3. Upon actuation, piezo element 3 acts, via a mechanical assemblage that has a coupler 5 and is here located vertically below, on a nozzle needle 6 in such a way that in this case a nozzle opening 7 can be cleared. A fuel guided in the interior of piezo actuator 1 through inner space 4 of holding body 2 can thus be injected into the combustion chamber of an internal combustion engine (not depicted here).

According to FIG. 2, piezo element 3 abuts at the top, via an actuator base 8, against a crowned sealing seat in inner space 4 of holding body 2, piezo element 3 being pressed with a spring 9 to produce a good sealing fit. Especially in the case of so-called common rail (CR) systems, a high-pressure seal is necessary here with respect to an electrical connection space, disposed above piezo element 3 and above inner space 4 in holding body 2, through which the electrical conductors are guided for electrical contacting to piezo element 3.

Installation-specific piezo actuator requirements can be met more easily and more economically with a two-part holding body encompassing an upper holding body part and a lower holding body part. The upper holding body part is predominantly adapted to the boundary conditions defined by the specific installation conditions, whereas the lower holding body part is adapted predominantly to the boundary conditions defined by the dimensions and geometry of the piezo element and by flow guidance of the fluid in the inner space.

The existing art is electrical contacting, depicted in FIG. 2, to the piezo element via a high-pressure-tight sealing bushing, fused into glass, in the actuator base of the piezo element. In a two-part holding body not having a plug-type connection, this technology cannot be verified.

Piezo actuators having a two-part holding body, in particular, require that the electrical contacts for the piezo element leading through the upper holding body part to the piezo element be embodied as a plug connection, so that the electrical contacts leading through the upper holding body part can be tested for functionality and, in particular, for external sealing with respect to the fluid, for example a fuel, passing at high pressure into the inner space.

The problem resulting from this is that, especially as piezo actuators become increasingly smaller, it is very difficult to produce a reliable and secure electrical plug connection in the very small available installation space. The problem is further aggravated by the fact that the flow conduit or conduits for delivery of the fluid that can be metered with the piezo actuator is/are also disposed in the region of the electrical contacts to the piezo element that pass through the holding body or the upper holding body part. In a typical embodiment of a piezo actuator used as an injector, in which embodiment the external electrical terminals for electrical contacting of the piezo element are disposed in the axial extension of the piezo element, and the connector for the fuel to be metered is disposed laterally on the holding body or on the upper holding body part, the flow conduit connecting the fuel connector to the internal space intersects the electrical contacts. This results in problems, in particular because of the small dimensions of the piezo actuator in the region of the upper holding body part and the resulting small installation space that is available, in effecting secure and reliable electrical contacting in the region of the plug connection.

### SUMMARY OF THE INVENTION

The disadvantages arising from the problems of the existing art are avoided, in a piezo actuator according to the exemplary embodiments and/or exemplary methods of the present invention of the aforementioned species, by the fact that the flow conduit connecting the inner space and the connector for the fluid is offset radially outward with respect to electrical conductors leading through the holding body and substantially forming the electrical contact system, and is disposed in a manner running substantially parallel to them; and that an electrical plug connection connecting the piezo element to the electrical conductors is disposed between the holding body and piezo element. The result of the flow conduit disposed parallel to the electrical conductors leading through the holding body is that the installation space available in the holding body for placement of the electrical plug connection is enlarged as compared with the existing art.

In the context of a utilization as a piezo injector, the piezo actuator according to the exemplary embodiments and/or exemplary methods of the present invention has, as compared with the existing art, the advantage that because of the axially parallel disposition of the flow conduit with respect to the electrical conductors in the holding body above the inner space, a great deal of installation space remains for a robust and reliably functioning electrical plug connection between the piezo element and the electrical conductors disposed in the holding body. The larger installation space available as compared with the existing art allows the use of larger-diameter plugs and sockets so that pins, contact sleeves, and the wires constituting the electrical conductors can in general be designed with larger diameters. Electrical properties are consistently improved, particularly in terms of less voltage drop and lower contact resistance values in the region of the plug connection.

An advantageous embodiment of the present invention provides that the flow conduit connecting the connector for the fluid to be metered to the inner space proceeds substantially parallel to the plane that is formed by the electrical conductors that proceed substantially parallel to one another and create the two-pole electrical contact system, which plane divides the holding body axially with respect to the piezo element.

Another advantageous embodiment of the present invention provides that the holding body is embodied in two parts, and the electrical plug connection, the flow conduit, and the connectors for the fluid and for electrical contacting are disposed in an upper holding body part delimiting the inner space at the end from the one side, and the inner space receiving the piezo element is constituted substantially by a lower holding body part. It is conceivable in this context that the piezo element is disposed on a front wall, delimiting the inner space at the end face, of the upper holding body part of the two-part holding body.

An additional advantageous embodiment of the present invention provides that the connector for electrical contacting is disposed substantially axially with respect to the piezo element disposed in the inner space, and the connector for the fluid is disposed at an angle with respect to the longitudinal axis of the piezo element.

A particularly advantageous embodiment of the present invention provides that the plug connection encompasses sockets disposed in the holding body, and plugs disposed on the piezo element. The plugs of the piezo element project therefrom, so that after assembly of the piezo element with the holding body, the plug connection is located entirely in the holding body. Advantageously, provision is made in this context that the sockets encompass sleeves connected in electrically conductive fashion to the electrical conductors made up, for example, of individual wires.

An additional, particularly advantageous embodiment of the present invention provides that the piezo element encompasses an actuator base terminating the piezoelectric ply stack in the direction of the holding body, the actuator base being fixedly connectable to the holding body, for example by way of a weld connection or an adhesive connection.

### BRIEF DESCRIPTION OF THE DRAWINGS

FIG. 1 shows a longitudinal section through a piezo actuator according to the present invention, having a two-part holding body encompassing an upper holding body part and a lower holding body part, and having a flow conduit that extends in the upper holding body part axially parallel to electrical conductors serving for electrical contacting of the piezo element and that connects the inner space to the connector for the fluid to be metered.

FIG. 2 shows a piezo actuator according to the existing art.

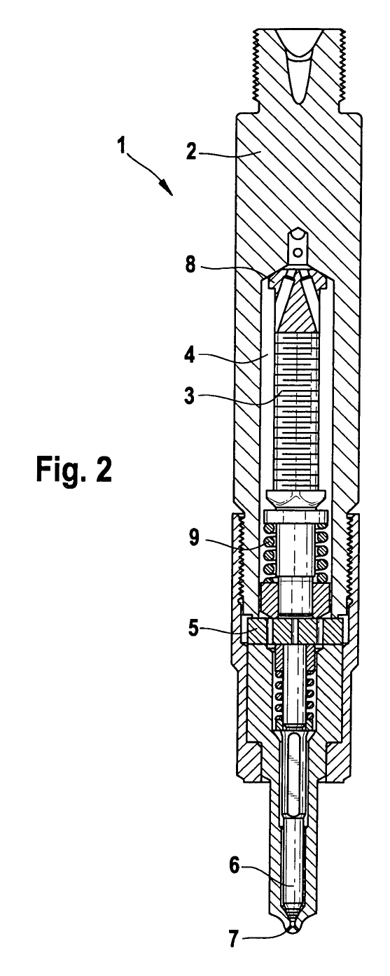

### DETAILED DESCRIPTION

The exemplary embodiments and/or exemplary methods of the present invention will be described below using the example of a piezo actuator for use as a common rail fuel injector with direct needle control.

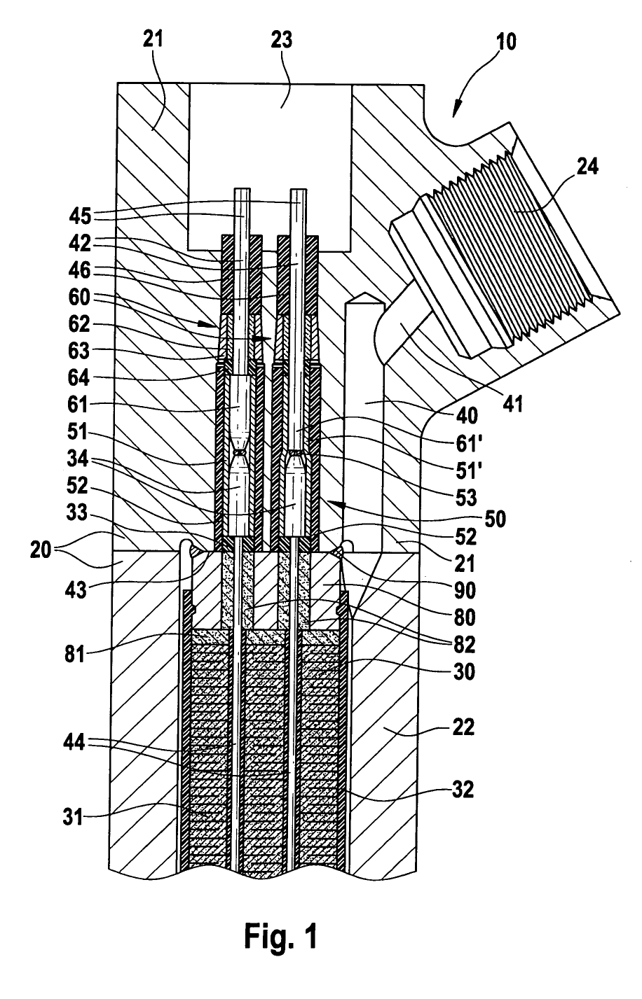

A piezo actuator 10 according to the present invention depicted in FIG. 1 is made up substantially of a two-part holding body 20 having an inner space 40, as well as a piezo element 30 disposed in inner space 40 and electrically contactable through holding body 20. The piezo element encompasses multiple piezoelectric plies disposed to form a stack 31. Holding body 20 encompasses an upper holding body part 21 as well as a lower holding body part 22.

Upper holding body part 21 has a connector space 23 for an electrical connector for electrical contacting of piezo element 30 by way of conductors 42 guided through holding body 20, more precisely through upper holding body part 21. Upper holding body part 21 furthermore has a connector space 24 for delivery into inner space 40 of a fuel that can be metered by way of an adjusting element encompassing piezo element 30, as well as a flow conduit 41 leading from connector space 24 into inner space 40.

Electrical connector space 23 is disposed in the axial extension of piezo element 30. Electrical conductors 42 thus proceed coaxially with the longitudinal axis of piezo element 30. Flow conduit 41 is offset radially outward with respect to electrical lines 42 that lead through upper holding body part 21 and substantially constitute the electrical contact system, and is disposed to run substantially parallel to them. In FIG. 1, the axially parallel flow conduit 41 is shown rotated 90 degrees with respect to electrical conductors 42. In a longitudinal section through piezo actuator 10 rotated 90 degrees, it would be apparent that flow conduit 41 proceeds substantially parallel to a plane that is formed by electrical conductors 42 and that divides holding body 20 axially with respect to piezo element 30. As a result, a great deal of installation space remains in upper holding body part 21 for electrical contacting of piezo element 30.

Flow conduit 41 opens into the annular space of inner space 40 remaining between piezo element 30 and lower holding body part 22, which part concentrically encases piezo element 30. In operation, piezo element 30, which encompasses an insulating sleeve 32 corresponding in its internal cross-sectional dimensions to the external cross-sectional dimensions of piezo element 30, is surrounded by the fuel flowing through the remaining annular space of inner space 40. Such a configuration is referred to as a wet configuration.

Lower holding body part 22 substantially forms inner space 40 that concentrically receives piezo element 30. Lower holding body part 22 radially delimits inner space 40, and thus substantially defines the length and cross section of inner space 40. Upper holding body part 21 delimits inner space 40 at one end face. Electrical conductors 42, flow conduit 41, and connector spaces 23, 24 are substantially disposed in upper holding body part 21.

Piezo element 30 is electrically connected, via an electrical plug connection 50, to conductors 42 disposed in upper holding body part 21.

Electrical plug connection 50 is disposed between upper holding body part 21 and piezo element 30. Piezo element 30 encompasses: an actuator base 80 terminating piezoelectric ply stack 31 (not depicted in further detail) at the end toward upper holding body part 21, on which base are disposed plug pins 34 constituting the piezo-element part of plug connection 50; and a ceramic insulator 81 disposed between actuator base 80 and piezoelectric ply stack 31. Electrodes 44 serve for internal contacting of the piezoelectric plies. Ceramic sleeves 82 encasing electrodes 44 are disposed in the region of actuator base 80. The holding-body part of plug connection 50 is disposed in a front wall 43 of upper holding body part 21, which wall delimits inner space 40 at the end.

Electrical plug connection 50 is made up of plug pins 34 disposed on piezo element 30, which are equipped with insulating rings 33. Contact sleeves 51, 51′, forming the counterelement to plug pins 34, are disposed in upper holding body part 21. Contact sleeves 51, 51′ are connected in electrically conductive fashion to plug pins 61 disposed on the electrical conductors. The free ends 45, facing away from plug connection 50, of electrical conductors 42 are equipped with insulators 46 and can be contacted in connector space 23 with a plug.

In order to produce the holding-body part of plug connection 50, contact sleeves 51, 51′ having insulators 52, 52′ are introduced into upper holding body part 21; if necessary, insulating sleeves 52, 52′ can be adhesively bonded to upper holding body part 21. In addition, sealing sockets 60 fused into glass—which are made of plug pin 61, fused glass insert 62, conical steel sleeve 63, and a heat-shrink insulating ring 64 as parts—are hydraulically pressed into upper holding body part 21. This results in reliable sealing, with respect to the environment, of the fuel that is conveyed under high pressure into inner space 40.

As an alternative thereto, plug pins 61 that are disposed in the upper holding body part and are connected in electrically conductive fashion to electrical conductors 42 and contact sleeves 51 can also be constituted by wire 61′ constituting the electrical conductors, which wire is connected in electrically conductive fashion directly to the respective contact sleeve 51′. A plug pin of this kind can be manufactured more economically.

To further improve the sealing of inner space 40 with respect to the environment, piezo element 30 is fixedly placed on front wall 43 of upper holding body part 21, which wall delimits inner space 40 at the end. A weld connection 90 fixedly joining actuator base 80 to front wall 43 serves for fixed placement of piezo element 30 on front wall 43 of upper holding body part 21.

Alternatively, piezo element 30 can also be fixedly joined to upper holding body part 21 by way of an adhesive join between actuator base 80 and front wall 43.

A fixed peripheral connection as produced, for example, by weld connection 90 results in sealing of plug connection 50 with respect to inner space 40 that is filled with fuel under high pressure.

It is important to note that because of the axially parallel disposition of flow conduit 41 in upper holding body part 21, a great deal of installation space remains for producing a robust and functionally reliable plug connection 50. The larger installation space available as compared with the existing art allows the use of larger diameters for plug pins 34, 61, 61′ forming electrical plug connection 50, for contact sleeves 51, 51′, and for wires forming electrical conductors 42. This yields an improvement in electrical properties, especially in terms of less voltage drop and lower contact resistance values, as well as greater robustness.

For example, in the context of a high power demand from piezo element 30, or as a result of a high contact resistance brought about, for example, by oxidation, plug connection 50 can additionally be provided with a soft-solder ring 53 that can be soldered by induction soldering, or with a conductive adhesive.

Plug connection 50 and/or piezo element 30 and/or upper holding body part 21 may have color markings for polarity recognition and/or for correctly positioned placement of piezo element 30 relative to front wall 43 of upper holding body part 21.

Piezo element 30 is assembled and welded to upper holding body part 21 in correctly positioned fashion by way of color marking.

Because electrical plug connection 50 is disposed between upper holding body part 21 and piezo element 30, the location at which piezo element 30 is disposed on front wall 43 delimiting inner space 40 of holding body 20 is substantially more easily accessible, in terms of the manufacturing process, than in the existing art. The leak-tightness of the electrical contact system disposed in upper holding body part 22 can furthermore be verified.

The exemplary embodiments and/or exemplary methods of the present invention is industrially applicable in particular in the field of manufacturing piezo actuators for use in conjunction with fuel injectors for internal combustion engines.

1-10. (canceled)

11. A piezo actuator, comprising:
a holding body having an inner space;
a piezo element disposed in the inner space and encompassing multiple piezoelectric plies disposed to form a stack, wherein the piezo element is electrically contactable through the holding body, the holding body having at least one connector for electrically contacting the piezo element, wherein at least one connector and a flow conduit are for delivering, into the inner space, a fluid that is meterable by an adjusting member encompassing the piezo element, and wherein the flow conduit connecting the inner space and the at least one connector for the fluid is offset radially outwardly with respect to the electrical conductors leading through the holding body and substantially constituting the electrical contact system, and is disposed to extend substantially parallel to said conductors; and
a plug connection arrangement, which is to connect the piezo element to the electrical conductors, disposed between the holding body and the piezo element.

12. The piezo actuator of claim 11, wherein the flow conduit proceeds substantially parallel to a plane that is formed by the electrical conductors and that divides the holding body axially with respect to the piezo element.

13. The piezo actuator of claim 11, wherein the holding body is embodied in two parts, and the electrical plug connection, the flow conduit, and the connectors for the fluid and for providing electrical contacting are disposed in an upper holding body part delimiting the inner space at an end from one side, and wherein the inner space that receives the piezo element is constituted substantially by a lower holding body part.

14. The piezo actuator of claim 13, wherein the piezo element is disposed on a front wall, delimiting the inner space at the end face, of the upper holding body part.

15. The piezo actuator of claim 11, wherein the connector for electrically contacting is disposed substantially axially with respect to the piezo element, and the connector for the fluid is disposed at an angle with respect to the longitudinal axis of the piezo element.

16. The piezo actuator of claim 11, wherein the plug connection arrangement encompass sockets disposed in the holding body, and plugs disposed on the piezo element.

17. The piezo actuator of claim 16, wherein the sockets encompass sleeves connected electrically conductively to the electrical conductors.

18. The piezo actuator of claim 11, wherein the piezo element encompasses an actuator base terminating the piezoelectric ply stack in a direction of the holding body, the actuator base being fixedly connectable to the holding body.

19. The piezo actuator of claim 18, wherein the actuator base is connected to the holding body by a weld connection.

20. The piezo actuator of claim 18, wherein the actuator base is fixedly connected to the holding body by an adhesive connection.
